(19) United States
(12) Patent Application Publication
(10) Pub. No.: US 2010/0191660 A1
(43) Pub. Date: Jul. 29, 2010

(54) SYSTEMS AND METHODS FOR BANKRUPTCY CASE MANAGEMENT

(75) Inventors: Edward M. Burr, Scottsdale, AZ (US); Michael Yoder, Las Vegas, NV (US); Victor Bello, Las Vegas, NV (US)

Correspondence Address: THE NOBLITT GROUP, PLLC, 4800 NORTH SCOTTSDALE ROAD, SUITE 6000, SCOTTSDALE, AZ, 85251, US

(73) Assignee: Sierra Case Management Services, LLC (an Arizona limited liability company)

(21) Appl. No.: 12/604,321

(22) Filed: Oct. 22, 2009

Related U.S. Application Data
(60) Provisional application No. 61/107,642, filed on Oct. 22, 2008.

(51) Int. Cl. G06Q 10/00

(52) U.S. Cl. 705/311; 705/1.1

(57) ABSTRACT

Systems and methods for managing bankruptcy cases may comprise a computer system comprising a medium storing instructions for managing a bankruptcy case. The computer system may include an interface for a user to access at least one computer program for managing the bankruptcy case and a database to electronically store bankruptcy case data.

### CROSS-REFERENCES TO RELATED APPLICATIONS

This application claims the benefit of U.S. Provisional Patent Application No. 61/107,642, filed Oct. 22, 2008, and incorporates the disclosure of the application by reference.

### BACKGROUND OF INVENTION

Managing and resolving a bankruptcy case can be a cumbersome endeavor that involves many tasks, resources, and the coordination of numerous people and entities, such as debtors, creditors, legal entities, businesses, government, etc. For example, management of a bankruptcy case may comprise collecting, organizing, importing, and/or exporting claim data and the like. The management of a bankruptcy case may also comprise preparing ballots, statements of financial affairs, schedules of assets and liabilities, reports, and the like. The bankruptcy case may further comprise compilations of significant information, for example claim schedules, which may comprise debtor name and case number, creditor name, creditor address, creditor claim amount and class, and/or return mailing instructions, which may also be extracted to processing forms such as a proof of claim. Throughout the bankruptcy case, generated reports may be used as exhibits in a claims objection process, for example exhibits such as amended claims, duplicate claims, disputed claims, other customizable objections, and the like may be used. The management of bankruptcy case may also comprise creating and/or filing bankruptcy petitions and related documents, such as unsecured claims, and other first-day filings.

### SUMMARY OF THE INVENTION

In accordance with exemplary embodiments of the present invention, computer-implemented systems and methods for managing bankruptcy cases may comprise a computer system comprising a medium storing instructions for managing a bankruptcy case. The computer system may include an interface for a user to access at least one computer program for managing the bankruptcy case and a database to electronically store bankruptcy case data.

### BRIEF DESCRIPTION OF THE DRAWINGS

A more complete understanding of the present invention may be derived by referring to the detailed description and claims when considered in connection with the following illustrative figures. In the following figures, like reference numbers refer to similar elements and steps throughout the figures.

FIG. 1 comprises a block diagram of an exemplary bankruptcy management system in accordance with an exemplary embodiment of the present invention;

FIG. 2 comprises a screen shot of a form on a website page to create a new bankruptcy case in accordance with an exemplary embodiment of the present invention;

FIG. 3 comprises a block diagram of exemplary bankruptcy case management components in accordance with an exemplary embodiment of the present invention;

FIG. 4 comprises a screen shot of an exemplary website homepage in accordance with an exemplary embodiment of the present invention;

FIG. 5 comprise a screen shot of an exemplary website new account registration page in accordance with an exemplary embodiment of the present invention;

FIG. 6 comprises a screen shot of an exemplary website work area page in accordance with an exemplary embodiment of the present invention;

FIG. 7 comprises a screen shot of an exemplary website bankruptcy case management page in accordance with an exemplary embodiment of the present invention;

FIG. 8 comprises a screen shot of an exemplary website page to provide claims reconciliation in accordance with an exemplary embodiment of the present invention;

FIG. 9 comprises a screen shot of an exemplary website page to provide claims disbursement in accordance with an exemplary embodiment of the present invention;

FIG. 10 comprises a screen shot of an exemplary website page to prepare proofs of claims in accordance with an exemplary embodiment of the present invention;

FIG. 11 comprises a screen shot of an exemplary website page to enter returned proof of claim information in accordance with an exemplary embodiment of the present invention;

FIG. 12 comprises a screen shot of an exemplary website page to provide an amended claim report in accordance with an exemplary embodiment of the present invention;

FIG. 13 comprises a screen shot of an exemplary website page to create or edit ballot in accordance with an exemplary embodiment of the present invention;

FIG. 14 comprises a screen shot of an exemplary website page to record ballot votes in accordance with an exemplary embodiment of the present invention;

FIG. 15 comprises a screen shot of an exemplary website page to provide balloting reports in accordance with an exemplary embodiment of the present invention;

FIG. 16 comprises a screen shot of an exemplary website page to create service lists and edit parties in accordance with an exemplary embodiment of the present invention; and

FIG. 17 comprises a screen shot of an exemplary website page to electronically file documents with a court in accordance with an exemplary embodiment of the present invention.

Elements and steps in the figures are illustrated for simplicity and clarity and have not necessarily been rendered according to any particular sequence. For example, steps that may be performed concurrently or in different order are illustrated in the figures to help to improve understanding of embodiments of the present invention.

### DETAILED DESCRIPTION OF EXEMPLARY EMBODIMENTS

The present invention may be described in terms of functional block components and various processing steps. Such functional blocks may be realized by any number of hardware or software components configured to perform the specified functions and achieve the various results. For example, the present invention may employ various computers, networks, servers, and databases, such as webservers, the Internet, local networks, and the like, which may execute a variety of functions. In addition, the present invention may be practiced in conjunction with any number of networks, types of information, or participants, and the systems and methods described are merely exemplary applications for the invention. Further, the present invention may employ any number of conventional techniques for transferring data, presenting information, storing information, transforming data and information, and the like.

Methods and apparatus for management of a bankruptcy case according to various aspects of the present invention may operate in conjunction with a computer system configured to collect, organize, import, and export case data and the like. Methods and apparatus for management of the bankruptcy case may facilitate creating and/or filing bankruptcy petitions and related documents, such as claims and first-day filings. For example, methods and apparatus for management of the bankruptcy case may comprise preparing ballots, statements of financial affairs, schedules of assets and liabilities, reports, and the like. Methods and apparatus for management of the bankruptcy case may also generate reports for a variety of purposes, such as exhibits in a claims objection process, including amended claims, duplicate claims, disputed claims, customizable objections, and the like. Users of the computer system 100 may be any appropriate individual, group, or system, such as an administrator, a creditor, a debtor, a court, a court employee, a machine associated with such entities, and the like.

The various functions of the computer system may also facilitate management of bankruptcy cases, such as by helping creditors determine the type of claim and/or identify the debtor to file a claim against, and streamline the claim objection process by matching a unique claim identification number to the scheduled amount so that the number of claim objections can be reduced. In accordance with exemplary embodiments of the present invention, the computer system may be configured to manage the bankruptcy case further by providing for pre-printed ballots, for payments of claims, and for on-line public access so that interested parties may review, provide, and/or download various information. Methods and apparatus for management of the bankruptcy case may also comprise or operate in conjunction with compilations of information, for example claim schedules, which may include information such as debtor name and case number, creditor name, creditor address, creditor claim amount and class, and/or return mailing instructions, which may also be exported to processing forms such as a proof of claim.

The computer system may also be configured to manage the bankruptcy case by allowing more than one user access to the bankruptcy case being managed. In this manner, various users can easily input and amend data, documents, reports, forms, and the like, to ensure such documents, reports, forms, and the like are timely filed and accurate. The computer system may be configured to manage the bankruptcy case by receiving data in a manual manner or the data may be downloaded, for example, by importing data from a website, a database, a spreadsheet such as Excel®, and the like.

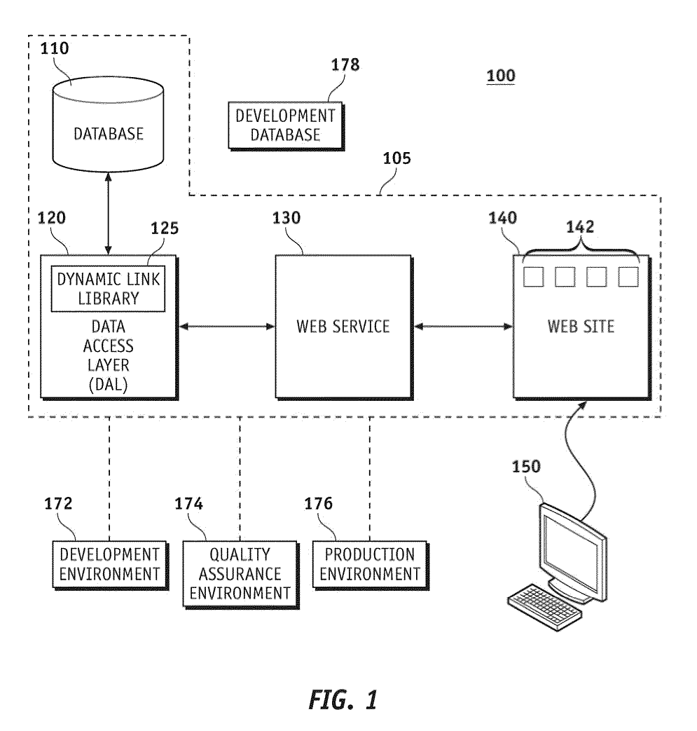

With reference to FIG. 1 and in accordance with an exemplary embodiment of the present invention, a computer system 100 according to various aspects of the present invention may operate in conjunction with machine-readable instructions, a medium storing such instructions, and/or computer-implemented methods configured to manage at least one bankruptcy case. In an exemplary embodiment, the computer system 100 may comprise a central system comprising processing components 105 to execute various functions. Exemplary embodiments of the present invention may also comprise various other computer system components to facilitate use of the computer system 100, for example hardware like monitors, CPUs, printers, networks, and the like, as well as software configured to operate and/or inter-operate the various hardware components. The various components described are merely exemplary embodiments of hardware and software components to facilitate managing a bankruptcy case. In other words, the various computer systems, components, hardware and software, as well as the manner in which they inter-operate, are exemplary elements used to provide for managing all or substantially all aspects of a bankruptcy case via the computer system 100.

The processing components 105 facilitate storage of information relating to a bankruptcy case, as well as access and use of such information, and may comprise any appropriate elements and systems. For example, the processing components 105 may comprise a database 110, a data access layer (“DAL”) 120, and an interface. The database 110 stores information related to the bankruptcy case. The DAL 120 provides connectivity for the database 110 via the interface. The interface facilitates access to the database via the DAL 120, such as a website 140 operating in conjunction with a web service 130.

In accordance with exemplary embodiments, the computer system 100 may comprise or operate in conjunction with various system components to update, manage, develop, test, and the like, the processing components 105. For example, the computer system 100 may comprise a development environment 172 to provide a computing area to further develop processing components 105, to develop additional processing components, and to develop any other elements to further enhance the functionality of the computer system 100 and its functions. For example, development environment 172 may allow for testing of newly developed processing components 105, software, web-site functions, processing component communication functions, etc.

The computer system 100 may also comprise a quality assurance environment 174 to provide an area to test, review, receive feedback, and otherwise assure the quality of the computer system 100 for users. The computer system 100 may further comprise a production environment 176 to provide a computing area for maximizing, maintaining, and/or managing the efficiency, operation, and/or functionality of the computer system 100 and its functions. The computer system 100 may also comprise a development database 178 to provide a computing area to develop the functionality, efficiency, and the like of the database 110.

These various system components, development environment 172, quality assurance environment 174, production environment 176, and development database 178 may be used for various software and/or hardware components of the computer system 100. The computer system 100, in other exemplary embodiments, may comprise additional and/or different environments to update, optimize, manage, develop, test, and the like of the processing components 105.

The database stores information for retrieval and use by the other elements of the computer system. The database 110 may comprise a structured collection of records and/or data that may be stored in the computer system 100. The structured collection of records and/or data may be achieved by organizing the data according to a database model, wherein the model may comprise a relational model, but other models such as a hierarchical model and/or a network model may use a more explicit representation of relationships. The database may comprise any appropriate electronic storage system and associated systems, such as a conventional storage system and associated database software. In accordance with exemplary embodiments of the present invention, the database 110 may comprise an entity-relational database comprising various tables that hold information and/or data relevant to a bankruptcy case.

In one embodiment, the database 110 stores information relating to multiple bankruptcy cases, such as information relating to the parties, the court, claims, documents, resolutions and reconciliations, payments, objections, and the like. For example, the database 110 may comprise some or all of the following exemplary tables, and other tables may be changed, added and/or deleted. The various tables and a brief description of their functions and/or the data the various tables store are shown in Table Summary I below.

TABLE SUMMARY I

| TABLE NAME | TABLE FUNCTION |
|---|---|
| Address | These exemplary tables may comprise the addresses stored by |
| | a computer system, for example, party, company, and/or user address. |
| Address Type | These exemplary tables may comprise LOOKUP TABLES |
| | that comprise lists of address types allowed by a computer |
| | system. These tables may coordinate with address tables |
| | through an identifier. |
| ASP.NET Tables | These exemplary tables may be used for membership |
| | purposes. The login registration and a computer system's |
| | users may be coordinated by these tables. |
| Ballot | These exemplary tables may comprise information for ballots |
| | created by a computer system's users. |
| Ballot Party | These exemplary tables may comprise parties that may be |
| | included into ballots, which may further comprise a voting |
| | amount assigned to them. |
| Ballot Question | These exemplary tables may comprise questions included on |
| | ballots. |
| Ballot Vote | These exemplary tables may comprise party votes with |
| | respect to each question on each ballot. |
| B Tool | These exemplary tables may comprise a company's credit |
| | card information. |
| Case Main | These exemplary tables may comprise bankruptcy case |
| | information created by a computer system's users. |
| Case Party | These exemplary tables may comprise the association |
| | between a party and their bankruptcy case. |
| Case User | These exemplary tables may comprise the association |
| | between a computer system's users and a specific bankruptcy |
| | case users may be assigned to manage. |
| Claim | These exemplary tables may comprise proof of claim |
| | information received from creditors. |
| Claim Objection | These exemplary tables may comprise different objections a |
| | user may assign to a creditor claim. |
| Claim Type | These exemplary tables may comprise LOOKUP TABLES |
| | comprising types of claim or claim class filed by a creditor. |
| Company | These exemplary tables may comprise company information. |
| | A user may be assigned to a specific company and each |
| | company may comprise of a single or multiple account |
| | administrators. |
| Company Address | These exemplary tables may comprise the association |
| | between a company and the company's billing address on file. |
| Company Payment | These exemplary tables may comprise information from each |
| | company's payment, and each record may comprise a |
| | transaction of a credit card charge. |
| Credential | These exemplary tables may comprise credit card credentials |
| | that may be used to charge a payment service, for example, |
| | PayPal ® Service. |
| Creditor Info | These exemplary tables may comprise additional party |
| | information used for scheduled users. |
| Discount | These exemplary tables may comprise coupons that may be |
| | generated for discounts, for example, “Free Case” or “3 |
| | Months Free” that a computer system's users may redeem |
| | upon registration. |
| Doc PREFIX Tables | These exemplary tables may comprise information for each |
| | bankruptcy schedule that a user creates through the interface |
| | and all the records may be stored on an “info SUFFIX” table. |
| | Additional Schedule information may be stored on “Plus |
| | SUFFIX” tables. |
| Document | These exemplary tables may comprise information about each |
| | document created on a computer system for each bankruptcy |
| | case. |
| Document List | These exemplary tables may comprise LOOKUP TABLES |
| | used for an interface. These tables may comprise a list of |
| | documents that are required to file a bankruptcy case or that |
| | are associated with a case. |
| Document Type | These exemplary tables may comprise LOOKUP TABLES |
| | that comprise a type of document that can be created on a |
| | computer system. These tables may coordinate with a |
| | document table through an identifier. |
| Mailing List | These exemplary tables may comprise party information that |
| | may be included on mailing lists. |
| Objection | These exemplary tables may comprise customizable |
| | objections created by a computer system's users. |
| Party | These exemplary tables may comprise party information, for |
| | example, name, e-mail, phone, etc. |
| Party Address | These exemplary tables may comprise the association |
| | between a party and the party's address. |
| Party Alias | These exemplary tables may comprise different Aliases that |
| | may be associated with a party, for example, the different |
| | Aliases on a voluntary petition document. |
| Party Identifier | These exemplary tables may comprise a party's identifier, for |
| | example, SSN's, TIN's, etc., associated with the party on a |
| | voluntary petition document. |
| Party Type | These exemplary tables may comprise LOOKUP TABLES |
| | that comprise the types of party that can be created in the |
| | computer system. |
| Pay Group | These exemplary tables may comprise different payments |
| | generated for creditors via a claim disbursements module. |
| Payment | These exemplary tables may comprise information about each |
| | individual payment to creditors from each individual pay |
| | group. |
| Pending Bankruptcy | These exemplary tables may comprise pending bankruptcy |
| | case information from a debtor listed on a voluntary petition |
| | document. |
| Petition | These exemplary tables may comprise voluntary petition |
| | document information. |
| Phone | These exemplary tables may comprise a party's phone |
| | number. |
| Phone Type | These exemplary tables may comprise LOOKUP TABLES |
| | that hold the types of phone that can be created into the |
| | system, for example, work, home, cell, etc. |
| Prior Bankruptcy by | These exemplary tables may comprise information about prior |
| Debtor | bankruptcy cases as listed on a voluntary petition document. |
| Public Document | These exemplary tables may comprise information about |
| | public documents published by a computer system's users for |
| | each bankruptcy case. |
| Reconciliation | These exemplary tables may comprise information about |
| | allowed amounts on each claim a computer system's users can |
| | create on a claims reconciliation page. |
| SOFA Prefix Tables | These exemplary tables may comprise a statement of financial |
| | affairs document information, the category, item and question |
| | suffix table, holds the values of the document inserted by a |
| | computer system's users. |
| Sub-class | These exemplary tables may comprise customizable sub- |
| | classes a computer system's users may create on a claims |
| | reconciliation page. |
| Top Twenty | These exemplary tables may comprise a list of the twenty (20) |
| | creditors holding the largest claims. |
| User Address | These exemplary tables may comprise a computer system's |
| | user's address. |
| User Profile | These exemplary tables may comprise a computer system's |
| | user's profile information. Each user has their relevant |
| | information stored in these tables. |

The database 110 may include any suitable information for managing one or more cases, and the tables listed in Table Summary I are not all inclusive and other tables may be added. Similarly, some of the tables may be deleted or changed to contain different information and/or configurations. The computer system 100 may also comprise other components to insert, delete and/or update information within the tables.

The DAL 120 may facilitate access to the database 110. The DAL 120 may comprise any suitable system for accessing the database 110, such as a conventional dynamic link library adapted to perform various functions for retrieving, modifying, and adding to the database 110 contents. The DAL 120 may comprise a layer comprising, for example, a computer program that may provide simplified access to data stored in persistent storage of some kind, such as an entity-relational database, e.g., database 110. The DAL 120 may be used in turn by other computer system 100 components to access and manipulate the data within the database 110 without having to coordinate with complexities inherent in such access.

For example, the DAL 120 might return a reference to an object (in terms of object-oriented programming) complete with its attributes instead of a row of fields from the database 110 table. This may allow the computer system 100 components to be created with a higher level of abstraction. Such components may be implemented by creating a class of data access methods that directly reference a corresponding set of database 110 stored procedures, for example the classes shown in Table Summary II below. Another implementation could potentially retrieve or write records to or from a file system, such as the database 110.

The DAL 120 may also hide the complexity of any underlying data stored from the external world. For example, instead of using commands such as “insert”, “delete”, and “update” to access a specific table in a database, a class and a few stored procedures may be created in a database, e.g., database 110. The procedures may be called from a method inside the class, which would return an object containing the requested values. Or, the “insert”, “delete” and “update” commands may be executed within simple functions, for example, “registeruser” or “loginuser” stored within the DAL 120. Moreover, a business logic method from an application may be mapped to the DAL 120. Thus, for example, instead of making a query into a database to fetch all users from several tables, the application may call a single method from a DAL, which may abstract to those database calls.

In accordance with exemplary embodiments, the components of the computer system 100 that use the DAL 120 may be database 110 server dependent or independent. If the computer system 100 comprising the DAL 120 supports multiple database types, the computer system 100 components may be able to use whatever databases the DAL 120 can interoperate with. Whether dependent or independent, the computer system 100 comprising the DAL 120 may provide a centralized location for all calls into the database 110.

In accordance with an exemplary embodiment, the DAL 120 component may coordinate the database 110 connections and the database 110 interactions using a database model. By using this DAL 120 component, the DAL 120 may allow the web service 130 to use a terminal emulator, for example WRQ® Reflection, to simplify the “insert”, “update” and “delete” functions into those three basic functions instead of handling multiple functions for each table in the database 110.

The DAL 120 may comprise a library of classes, sections and objects. The computer system 100 may comprise a medium storing instructions, machine readable language, and/or computer-implemented methods to provide for such a library of classes, sections and objects, and each of the classes, sections and objects in the library may hold functions related to each of the classes, sections and objects. Each of the classes, sections and objects may comprise or perform at least one of retrieving information; inserting information; updating information; and deleting information to and from the database 110.

In accordance with an exemplary embodiment, the various classes, sections and objects may comprise the following library as outlined in a Table Summary II.

TABLE SUMMARY II

| 1. | Case Class: | | This exemplary class may comprise |
|---|---|---|---|
| | | | functions related to bankruptcy case |
| | | | information. |
| | 1.1 | Get Case Information section: | This exemplary section may comprise a |
| | | | function that retrieves different sets of data |
| | | | related to bankruptcy case |
| | | | information. |
| | 1.2 | Insert Case Information section: | This section may comprise individual |
| | | | “INSERT” functions for each object in |
| | | | a database model related to bankruptcy |
| | | | case information. |
| | 1.3 | Update Case Information section: | This section may comprise individual |
| | | | “UPDATE” functions for each object in |
| | | | a database model related to bankruptcy |
| | | | case information. |
| | 1.4 | Delete Case Information section: | This section may comprise individual |
| | | | “DELETE” functions for each object in |
| | | | a database model related to bankruptcy |
| | | | case information. |
| 2. | Company Class: | | This class may comprise functions |
| | | | related to company information. |
| | 2.1 | Get Case Information section: | This section may comprise all functions |
| | | | that retrieve different sets of data |
| | | | related to company information. |
| | 2.2 | Insert Case Information section: | This section may comprise individual |
| | | | “INSERT” functions for each object in |
| | | | a database model related to company |
| | | | information. |
| | 2.3 | Update Case Information | This section may comprise individual |
| | | section: | “UPDATE” functions for each object in |
| | | | a database model related to company |
| | | | information. |
| | 2.4 | Delete Case Information section: | This section may comprise individual |
| | | | “DELETE” functions for each object in |
| | | | a database model related to company |
| | | | information. |
| 3. | Contact Class: | | This class may comprise functions |
| | | | related to contact information, e.g., |
| | | | addresses, phones numbers, etc. |
| | 3.1 | Get Case Information section: | This section may comprise functions |
| | | | that retrieve different sets of data |
| | | | related to contact information. |
| | 3.2 | Insert Case Information section: | This section may comprise individual |
| | | | “INSERT” functions for each object in |
| | | | a database model related to contact |
| | | | information. |
| | 3.3 | Update Case Information section: | This section may comprise individual |
| | | | “UPDATE” functions for each object in |
| | | | a database model related to contact |
| | | | information. |
| | 3.4 | Delete Case Information section: | This section may comprise individual |
| | | | “DELETE” functions for each object in |
| | | | a database model related to contact |
| | | | information. |
| 4. | Document Class: | | This class may comprise functions |
| | | | related to the bankruptcy case's |
| | | | documents, e.g., schedules, SOFA, etc. |
| | 4.1 | Get Case Information section: | This section may comprise functions |
| | | | that retrieve different sets of data |
| | | | related to bankruptcy case documents. |
| | 4.2 | Insert Case Information section: | This section may comprise individual |
| | | | “INSERT” functions for each object in |
| | | | a database model related to bankruptcy |
| | | | case documents. |
| | 4.3 | Update Case Information section: | This section may comprise individual |
| | | | “UPDATE” function for each object in |
| | | | a database model related to bankruptcy |
| | | | case documents. |
| | 4.4 | Delete Case Information section: | This section may comprise individual |
| | | | “DELETE” functions for each object in |
| | | | a database model related to bankruptcy |
| | | | case documents. |
| 5. | Party Class: | | This class may comprise functions |
| | | | related to Party information. |
| | 5.1 | Get Case Information Section: | This section may comprise functions |
| | | | that retrieve different sets of data |
| | | | related to party information. |
| | 5.2 | Insert Case Information Section: | This section may comprise individual |
| | | | “INSERT” functions for each object in |
| | | | a database model related to party |
| | | | Information. |
| | 5.3 | Update Case Information section: | This section may comprise individual |
| | | | “UPDATE” functions for each object in |
| | | | a database model related to party |
| | | | information. |
| | 5.4 | Delete Case Information section: | This section may comprise individual |
| | | | “DELETE” functions for each object in |
| | | | the database model related to party |
| | | | information. |
| 6. | Parent Class (main.cs) | | This section may comprise common |
| | | | information for a component library |
| | | | and functions that may pertain to a |
| | | | computer system's users. |
| | 6.1 | User Profile functions: | These functions may coordinate the |
| | | | “Insert”, “Update”, “Delete”, and |
| | | | retrieving of user profile information |
| | | | from the database. |
| | 6.2 | System Property: | Retrieves a Credential object that holds |
| | | | a PayPal billing module credential. |
| | 6.3 | Object Type ENUM: | This may comprise object types |
| | | | allowed to be used in Reflection ® by a |
| | | | web service. |

| | | |
|---|---|---|
| 7. | BallotInfo Class: | This class may comprise objects used |
| | | in Balloting that comprises Ballot |
| | | information as well as Ballot |
| | | Questions. |
| 8. | Ballot Party Vote Class: | This class may comprise an object that |
| | | comprises information on a Party Vote |
| | | regarding a specific Ballot Question. |
| 9. | Ballot Summary Class: | This class may comprise an object that |
| | | comprises information on a Ballot |
| | | Result, specifying information about |
| | | results on voting for a specific ballot. It |
| | | may also comprise certain properties to |
| | | be used in the presentation layer. |
| 10. | Case Payment Class | This class may comprise an object that |
| | | comprises information on each claim of |
| | | a bankruptcy case, with its scheduled |
| | | information and Proof of Claim |
| | | information along with all allowed |
| | | amounts used in a Claims |
| | | Reconciliation module. |
| 11. | Case Payment Class: | This class may comprise an object that |
| | | comprises information on each of the |
| | | payments made to creditors from a |
| | | Claim Disbursements module. |
| 12. | Company Billing Class: | This class may comprise an object that |
| | | comprises information on a company's |
| | | Billing Period; this information may be |
| | | used to calculate an amount a Company |
| | | needs to pay each month. |
| 13. | Party Ballot Class: | This class may comprise an object that |
| | | comprises information on each party |
| | | included in a Ballot. This information |
| | | may be used to present the computer |
| | | system's users with all creditors on file |
| | | and a status of their claim when |
| | | creating a new ballot or updating an |
| | | existing one. |
| 14. | Proof of Claim (“POC”) Objection | This class may comprise an object that |
| | Class: | comprises information on each |
| | | amended Proof of Claim that may be |
| | | objected to by a Debtor; it may |
| | | comprise information on surviving |
| | | Proof of Claims and Amended Proof of |
| | | Claims. |
| 15. | Public Case Class: | This class may comprise an object that |
| | | comprises information on each |
| | | bankruptcy case that may have public |
| | | documents published on a Public |
| | | Access Website. |

The classes, sections, and/or objects listed in the Table Summary II may not be all inclusive and other classes, sections, and/or objects may be added. Similarly, some of the classes, sections, and/or objects may be deleted or changed to contain different information and/or configurations to optimize the functionality of the present invention.

The functions and elements of the processing components 105 may be accessed and utilized in any appropriate manner. For example, the processing components 105 may be accessed locally or remotely. In various exemplary embodiments, the computer system 100 may communicate with a hardware device, such as a personal computer 150, which may access the processing components 105 locally or remotely.

For example, the computer system 100 may allow one or more of the processing components 105 to be accessed locally, such as via a conventional graphical user interface and a local network or a particular computer. For example, some or all of the processing components 105 may be packaged, distributed, published, downloaded, etc., in whole or in part, for direct access use on local computer systems. The various processing components 105 may also be configured for use among various types of computing systems. For example, some or all of the processing components 105 may be configured for use on a personal computer system, as part of an integrated computing network, as part of a handheld device, at a computer terminal integrated with a kiosk, etc.

The computer system 100 may also be configured for remote access by one or more users. For example, the computer system 100 may comprise the processing components 105 operating on a remote server that may be accessed remotely by several unrelated users, such as subscribers. In the present embodiment, the remote users may access the processing components 105 via the Internet or other suitable network, such as via the website 140 and the web service 130. The website 140 may comprise at least one computer application or module 142 to allow a user of the bankruptcy case management system to manage the bankruptcy case. The website 140 may also act as a portal and/or a presentation layer of the processing components 105, as well as other computer system 100 components. The web service 130 may be configured to provide inter-connectivity between the website 140 and the data access layer 120, wherein the inter-connectivity may comprise data retrieval web methods configured to retrieve and submit data, for example with the database 110.

The web service 130 may comprise any suitable system for facilitating interoperation with the database 110 and/or other processing components 105. For example, the web service 130 may comprise web methods and mechanisms to coordinate the connection between the DAL 120 component and the website 140. In one embodiment, the web service 130 may comprise Reflection® to coordinate the basic functions, and the web service 130 may comprise sections for data retrieval on each of the areas of the computer system 100. For example, the web service 130 may reference the DAL 120 component library as shown in the Table Summary III.

TABLE SUMMARY III

| 1. | Main | | |
|---|---|---|---|
| | 1.1 | User Management section: | This exemplary section may comprise a |
| | | | data retrieval web method to obtain a user's profile |
| | | | information. |
| | 1.2 | Basic Functions section: | This exemplary section may comprise web |
| | | | methods to “Insert”, “Update” and “Delete” |
| | | | data from a database. A ReflectObject |
| | | | function may use Reflection ® to send an |
| | | | object to a DAL to complete a function. It |
| | | | may also comprise a web method that |
| | | | retrieves credentials used in a PayPal ® |
| | | | billing module. |
| | 1.3 | Case Management Section: | This exemplary section may comprise data |
| | | | retrieval web methods to obtain relevant |
| | | | bankruptcy case information from a |
| | | | database. This section may coordinate |
| | | | information related to bankruptcy cases, |
| | | | ballots, disbursements, case users and a |
| | | | CheckCaseUser function that provides |
| | | | computer system users the permissions to |
| | | | work on a bankruptcy case. |
| | 1.4 | Document Management | This exemplary section may comprise data |
| | | Section: | retrieval web methods used to obtain |
| | | | bankruptcy case document information |
| | | | from a database. This section may |
| | | | coordinate statements and schedules, |
| | | | SOFA information, document types, |
| | | | voluntary petitions, etc. |
| | 1.5 | Party Management Section: | This exemplary section may comprise data |
| | | | retrieval web methods to obtain a party's |
| | | | information; every table or object regarding |
| | | | a party may be coordinated by this section. |
| | 1.6 | Contact Management section: | This exemplary section may comprise data |
| | | | retrieval web methods to obtain contact |
| | | | information for users, parties and |
| | | | companies in a computer system. It may |
| | | | coordinate addresses, phone numbers, and |
| | | | each of the relational tables that coordinate |
| | | | the different entities (company, party, and |
| | | | user) to the address. |

| | | |
|---|---|---|
| 2. | Membership Services: | This exemplary web service may |
| | | coordinate the ASP.NET membership |
| | | information. |

The sections listed in the Table Summary III are not all inclusive and other sections may be added. Similarly, some of the sections may be deleted or changed to comprise different web methods, information and/or configurations to optimize the functionality of the present invention.

The website 140 provides an interface for the user to utilize the processing components to manage the bankruptcy case. The website 140 may comprise at least one computer application or module 142 to allow a user of the bankruptcy case management system to manage a bankruptcy case. The website 140 may act as a portal and/or a presentation layer for the processing components 105, as well as other components. The website 140 may comprise multiple modules 142 for various functions, such as to direct a user through the cycle of a bankruptcy case, from creating the bankruptcy case to issuing payments to various creditors. The modules 142 may provide the functionality the users need to manage the bankruptcy case information and to generate documents to file in a court and provide reports on different aspects of the bankruptcy case. Exemplary modules are shown as follows in the Table Summary IV.

TABLE SUMMARY IV

| 1. | Case Management | | This exemplary module may comprise |
|---|---|---|---|
| | | | main functions of a bankruptcy case |
| | | | management system. This module may |
| | | | comprise all the functionality needed to |
| | | | manage a bankruptcy case from start to |
| | | | finish. |
| | 1.1 | Statements and Schedules | This exemplary Statements and Schedules |
| | | | module may allow a computer system's |
| | | | users to create bankruptcy-related |
| | | | comments by inputting information either |
| | | | manually or by uploading a spreadsheet |
| | | | template provided. |

| | | |
|---|---|---|
| 1.1.1 | Voluntary Petition | This exemplary module may allow a user |
| | | to manually enter Voluntary Petition |
| | | information to complete a Voluntary |
| | | Petition form. The form may be |
| | | subsequently generated into a particular |
| | | document format, for example, Word, PDF, |
| | | etc., for execution. |
| 1.1.2 | List of Creditors Holding | This exemplary module may allow a user |
| | 20 largest Unsecured Claims | to manually enter top 20 creditors. The top |
| | | 20 creditors may not be parties to the |
| | | bankruptcy case, but may be for |
| | | informational purposes on a document. |
| 1.1.3 | Summary of Schedules | This exemplary module may not require a |
| | | user to enter any information, but once a |
| | | user creates various individual schedules, |
| | | the user can generate a document, for |
| | | example, a PDF document, to file the |
| | | summary into a court. |
| 1.1.4 | Real Property - Schedule A | This exemplary module may allow a user |
| | | to manually enter each of the records that |
| | | pertain to a Schedule A. |
| 1.1.5 | Personal Property - | This exemplary module may allow a user |
| | Schedule B | to manually enter each of the records that |
| | | pertain to a Schedule B. |
| 1.1.6 | Property Claimed as | This exemplary module may allow a user |
| | Exempt - Schedule C | to manually enter each of the records that |
| | | pertain to a Schedule C. |
| 1.1.7 | Creditors Holding | This exemplary module may allow a user |
| | Secured Claims - Schedule D | to manually enter or upload a spreadsheet |
| | | comprising each of the records that pertain |
| | | to a Schedule D. |
| 1.1.8 | Creditors Holding | This exemplary module may allow a user |
| | Unsecured Priority Claims - | to manually enter or upload a spreadsheet |
| | Schedule E | comprising each of the records that pertain |
| | | to a Schedule E. |
| 1.1.9 | Creditors Holding | This exemplary module may allow a user |
| | Unsecured Non-priority Claims - | to manually enter or upload a spreadsheet |
| | Schedule F | comprising each of the records that pertain |
| | | to a Schedule F. |
| 1.1.10 | Executory Contracts and | This exemplary module may allow a user |
| | Unexpired Leases - Schedule G | to manually enter each of the records that |
| | | pertain to a Schedule G. |
| 1.1.11 | Co-debtors - Schedule H | This exemplary module may allow a user |
| | | to manually enter each of the records that |
| | | pertain to a Schedule H. |
| 1.1.12 | Declaration Concerning | This exemplary module may not require a |
| | Debtor's Schedules | user to enter any information, but once the |
| | | user creates various individual schedules |
| | | they can generate a PDF file to file the |
| | | declaration into a court. |
| 1.1.13 | Statement of Financial | This exemplary module may allow a user |
| | Affairs (SOFA) - Form 7 | to choose which questions may be relevant |
| | | to a bankruptcy case being managed and |
| | | add those questions to a document. Once |
| | | the questions have been answered, the user |
| | | may generate a document, for example, a |
| | | PDF document, to file with a court. |
| 1.1.14 | List of Equity Security | This exemplary module may allow a user |
| | Holders | to enter information regarding equity |
| | | holders for a debtor's company. The |
| | | module may generate a document, for |
| | | example, a PDF document, for execution |
| | | and filing with a court. |

| | | |
|---|---|---|
| 1.2 | Public Access Documents | This module may allow a user to choose |
| | | which bankruptcy case documents they |
| | | may have created from statements and |
| | | schedules the user wishes to publish and |
| | | make available to the public. The user may |
| | | also upload any other document for public |
| | | access and viewing. |
| 1.3 | Create Service Lists and Edit | This exemplary module may allow a user |
| | Party Information | to create customized service lists and |
| | | manage a party's information, for example, |
| | | name changes, address changes, etc. The |
| | | user may also print the list or export the list |
| | | to a spreadsheet comprising the ability to |
| | | publish the list to a public access window. |
| 1.4 | Claims Reconciliation | This exemplary module may allow a user |
| | | to view scheduled creditors that have filed |
| | | a proof of claim as well as unscheduled |
| | | creditors that may have filed a proof of |
| | | claim. This module may also allow users |
| | | to view available information to assist with |
| | | making a decision, and assign an allowed |
| | | amount to each of the claims on file. The |
| | | user may also generate a report from this |
| | | list. |
| 1.5 | Claims Disbursements | This exemplary module may allow a user |
| | | to generate payments to creditors that have |
| | | been assigned single or even several |
| | | allowed amounts. Each payment may be |
| | | recorded and/or deleted. Each individual |
| | | allowed claim amount may obtain a |
| | | payment on 1 of 2 different categories, for |
| | | example, a percentage of amount owed or a |
| | | prorated amount from a fixed payment to |
| | | all creditors. |
| 1.6 | Create Proof of Claims | This exemplary module may allow a user |
| | | to generate a document file, for example, a |
| | | PDF file, which may comprise the proof of |
| | | claims to mail to creditors. The proof of |
| | | claim may comprise pre-entered |
| | | information, for example, creditor ID, |
| | | scheduled amount, and scheduled class. In |
| | | some embodiments, the user may choose to |
| | | add additional information on an extra page |
| | | at the end of each proof of claim. |
| 1.7 | Enter Returned Proof of Claim | This exemplary module may allow a user |
| | | to take proof of claims sent to a court by |
| | | creditors and input all that information into |
| | | a computer system. The user may also |
| | | comprise the ability of uploading a |
| | | document, for example, a PDF document |
| | | that may have been sent by a court of a |
| | | digital version of the proof of claim filed. |
| 1.8 | Amended Claim Report | This exemplary module may retrieve a |
| | | report of a proof of claims that was |
| | | amended in the process of a bankruptcy |
| | | case, which may need to be objected to. |
| 1.9 | Ballots | This exemplary module may allow a user |
| | | to create customized ballots to send to |
| | | creditors so they can vote on a proposed |
| | | Payment Plan. The users may choose |
| | | which creditors they want included or |
| | | excluded from the ballots, and may choose |
| | | the number of questions they can add to the |
| | | ballot. The user may also be allowed to |
| | | assign a different voting amount than one |
| | | that was either scheduled or filed with the |
| | | proof of claim. |
| 1.10 | Record Ballot Votes | This exemplary module may allow a user |
| | | to take ballots received from creditors and |
| | | record creditors votes into a computer |
| | | system. |
| 1.11 | Balloting Results | This exemplary module may allow a user |
| | | to view a balloting process, as well as the |
| | | ballot results. The user may be able to |
| | | view current status of votes recorded into |
| | | the computer system and whether a |
| | | Payment Plan passed or failed. |
| 1.12 | CM/ECF | This exemplary module may comprise an |
| | | Internet link, which may correspond to an |
| | | appropriate jurisdictional court depending |
| | | on the District and State where the |
| | | bankruptcy case may be properly |
| | | adjudicated. A user may be directed to a |
| | | CM/ECF site of the court so that the user |
| | | may upload relevant bankruptcy documents |
| | | created by a computer system. |

| | | |
|---|---|---|
| 2. | My Work Area | The exemplary module may allow a user to |
| | | view the cases they have open on a |
| | | computer system as well as which cases the |
| | | user may work with. The user may also be |
| | | able to view a history of bankruptcy cases |
| | | previously closed. In some exemplary |
| | | embodiments, recent prepared bankruptcy |
| | | documents that have been updated on the |
| | | computer system may be viewed, for |
| | | example, at the bottom of a display page. |
| 3. | Create New Case | This exemplary module may allow a user |
| | | to create a new bankruptcy case for |
| | | management. The new bankruptcy case |
| | | may request the relevant, initial debtor |
| | | and/or joint debtor information where |
| | | applicable. |
| 4. | Manage Users | This exemplary module may allow a user |
| | | that may be registered on the “Account |
| | | Administrator” role to choose which other |
| | | users may be authorized to work on |
| | | bankruptcy cases that exist on a computer |
| | | system. The user may also have the ability |
| | | to create a new authorized user into the |
| | | company. |
| 5. | My Account | This exemplary module may allow a user |
| | | to update their account information and |
| | | change their password. The registered user |
| | | that belongs to the “Account |
| | | Administrator” role may also update |
| | | information on other authorized users that |
| | | belong to the user's company and be able |
| | | to reset the passwords and/or delete the |
| | | other authorized users. |
| 6. | Public Assess Website | This exemplary module may allow anyone |
| | | to view public documents via a website |
| | | portal. |
| 7. | System Management | This exemplary module may allow a |
| | | computer system administrator to bill a |
| | | user and/or their respective company, as |
| | | well as generate invoices. This module |
| | | may use a payment service, for example, a |
| | | PayPal Manager component to connect to |
| | | PayPal merchant services to coordinate |
| | | credit card charges. |

The modules listed in the Table Summary IV are not all inclusive and other modules may be added. Similarly, some of the modules may be deleted or changed to comprise different information and/or configurations to optimize the functionality of the present invention.

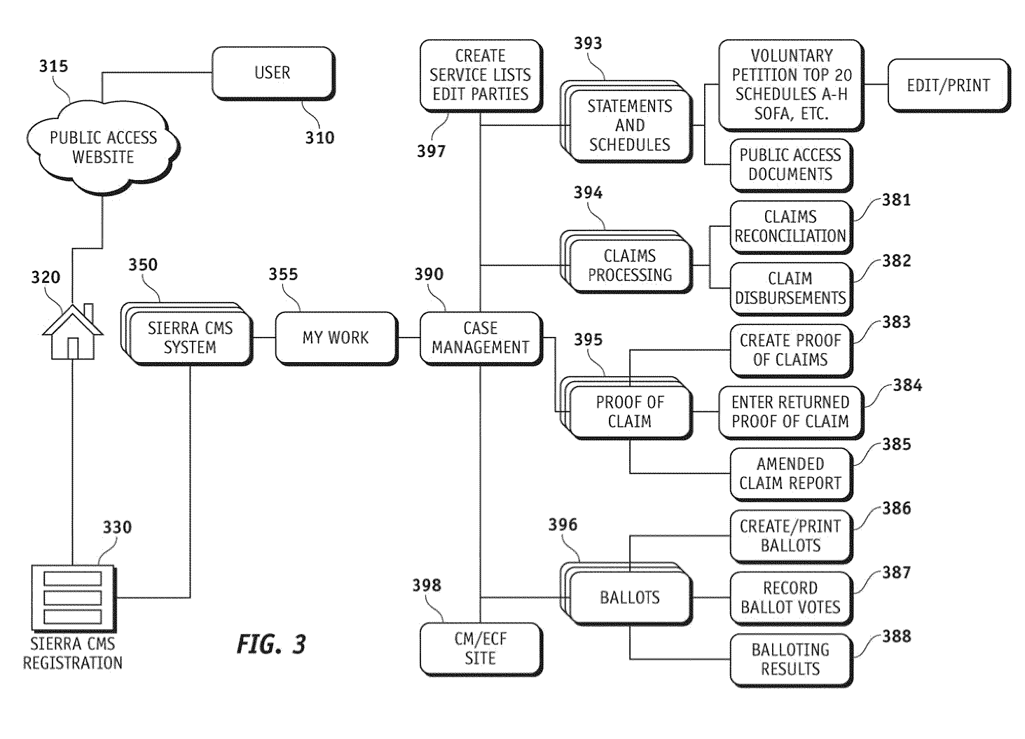

The computer system 100 may be used to manage a bankruptcy case, for example, in conjunction with the functions and elements described above. For example, and with reference to FIG. 3, a user 310 may access a public access website 315 that may act as a portal and presentation component to provide access and allow interaction with the various processing components. In one embodiment, the user 310 accesses a home page 320 to access a bankruptcy management system 350. The user 310 may access the bankruptcy management system 350 in any suitable manner, such as via a local connection or an interface other than a web-based interface.

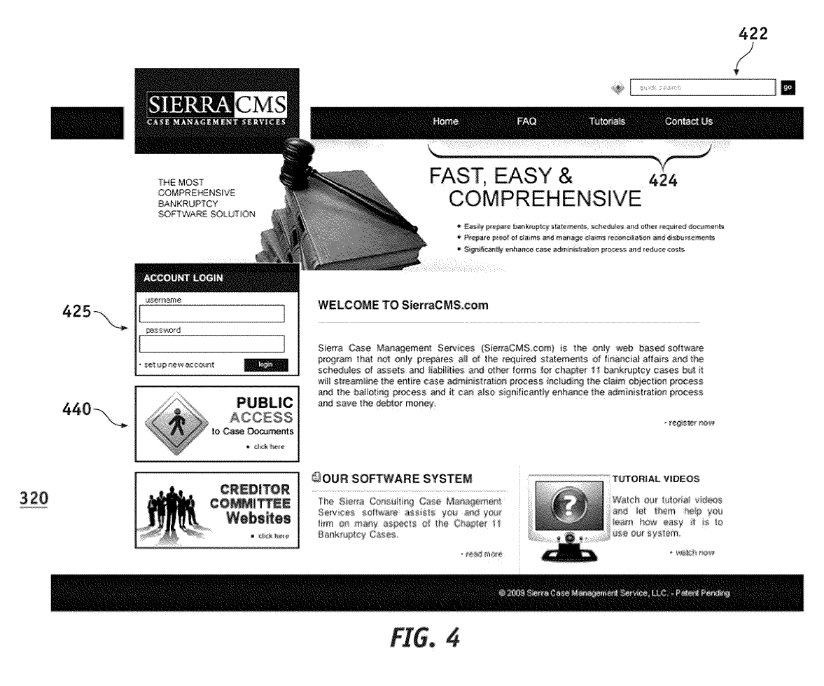

Referring to FIG. 4, an exemplary home page 320 allows the user 310 to initiate interaction with the bankruptcy management system 350. The home page 320 may comprise an account login section 425 such that the user 310 may enter a unique username and password to access an existing account or create a new account. The account login section 425 may then confirm the user 310, or optionally, may direct a new user, for example via a HTML link, to another website page where the new user may register to use the bankruptcy management system 350.

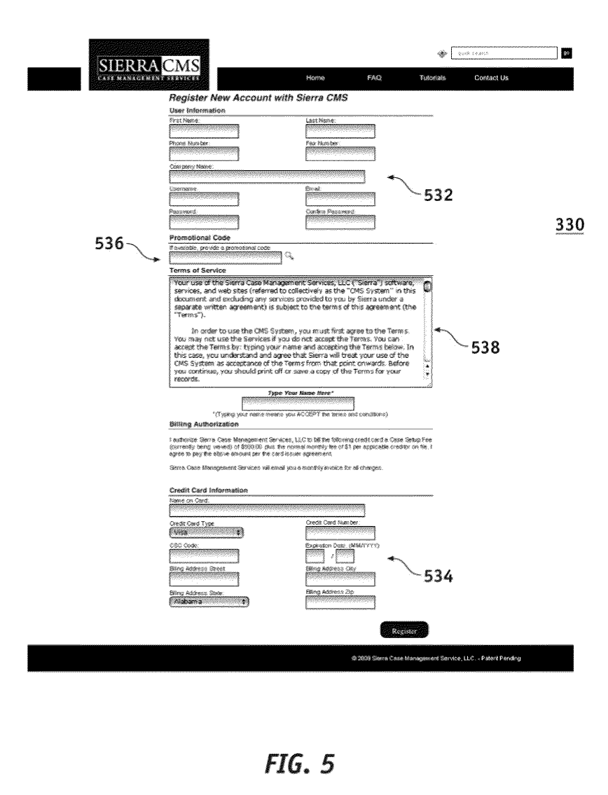

For example, referring to FIG. 5, an exemplary registration website page 330 may permit a new user to register to use the bankruptcy management system 350. The registration website page 330 may comprise a new user information section 532, wherein the new user may enter personal information such as name, phone number, address, e-mail, company name, etc. The new user information section 532 may also comprise a section for a new user to create and confirm a user identification and password for subsequent access to the bankruptcy management system 350.

The registration website page 330 may also comprise a section for a new user to enter billing information, for example into a billing information section 534. The billing information section may comprise fields for a new user to enter credit card information, such as credit card number, expiration date, billing address, credit card type, etc. In other exemplary embodiments, the billing information section 534 may also comprise checking account information fields so that the new user's checking account may be debited. The billing information section 534 may also comprise any other type of billing mechanism to pay fees.

The registration website page 330 may also comprise a section to enter a promotional code, for example promotional code section 536. A field in this section may allow a new user to take advantage of any special pricing or service promotions. The new user may enter a promotional code obtained through, for example, advertising, direct mailings, and the like, to provide the new user with a pricing discount and/or to obtain priority services. The registration website page 330 may also comprise a terms of service section 538 that details the terms of agreement between a new user and the operator of the bankruptcy management system 350. The new user information section 532, the billing information section 534, the promotional code section 536 and the terms of service section 538 are merely exemplary sections of the registration website page 330 and other exemplary embodiments may comprise some, all, or different sections for a prospective user to complete to gain access to the bankruptcy management system 350.

Referring again to FIG. 4, the bankruptcy management system home page 320 may also comprise other features, such as a public access link 440. The public access link 440 may allow the user 310 to view documents that have been designated for public access and any other “free” information throughout the website 315 without the need to formally register to use the bankruptcy management system 350. For example, selecting the PUBLIC ACCESS button may present the PUBLIC ACCESS page, which shows a list of cases. When a particular case is selected, a list of the publicly accessible documents for that case may be presented. The desired document can be selected for download or immediate viewing.

The home page 320 may also comprise any other information and/or links desired. For example, the home page 320 may comprise a search link 422 that may allow a user 310 to enter keywords or phrases to search the website 315, and may also include a link to creditor committee websites. The home page 320 may also comprise information links 424 that are generally common to websites, for example, a FAQ link, a tutorial link, a “Contact Us” link, and the like.

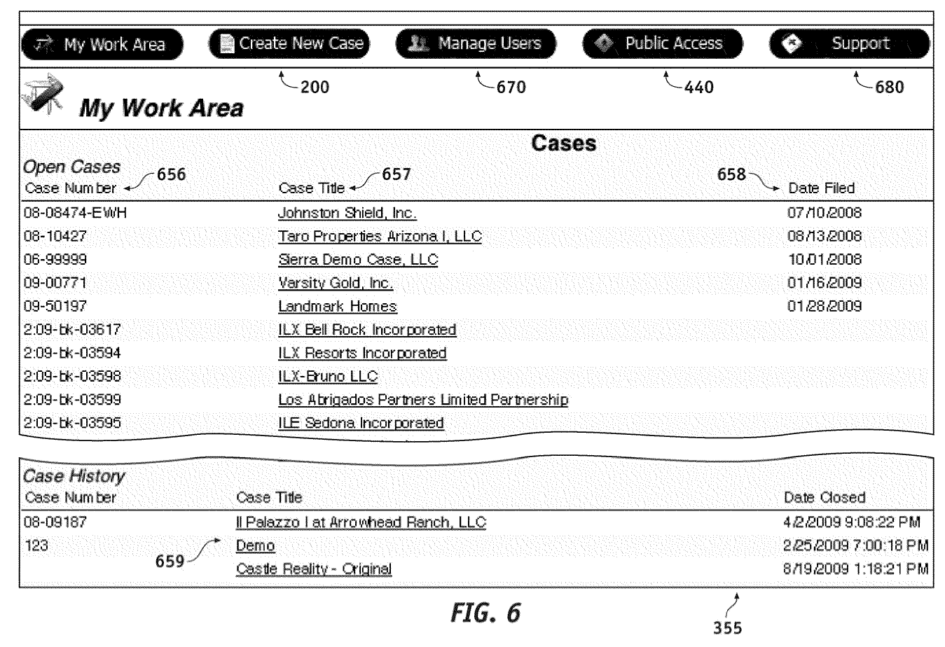

Returning again to FIG. 3, after a user 310 has been confirmed, for example by the account login section 425, the user 310 may be directed to a website page that allows the user 310 to manage one or more bankruptcy cases. For example, the user 310 may be directed to a “My Work” website page 355. Referring to FIG. 6, an exemplary “My Work” website page 355 may comprise information and links to bankruptcy cases the user 310 may be managing or otherwise associated with. For example, the “My Work” website page 355 may comprise a listing and links 656 to open bankruptcy cases being managed, the title of managed bankruptcy case 657, and a date 658 the bankruptcy case was filed, for example with a court. The “My Work” website page 355 may also comprise a listing and links 659 of other cases managed and resolved, and the date the case was closed.

The “My Work” website page 355 may also comprise links to other website pages within the bankruptcy management system 350 to further allow the user 310 to manage the bankruptcy case. For example, the website page 355 may provide links to create a new bankruptcy case 660, manage users 670, request support 680, and/or link to the public access page 440. The information and links described and shown by the “My Work” website page 355 merely constitute an exemplary embodiment of how the “My Work” website page 355 may be configured, and other information and links may added and/or deleted as desired to facilitate managing the bankruptcy case.

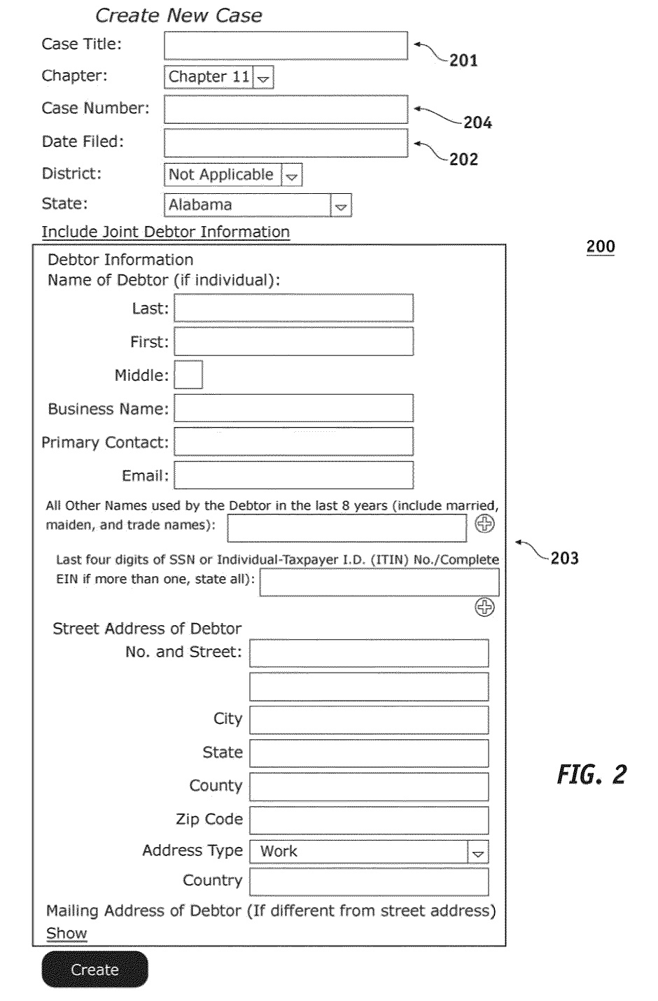

In the present embodiment, the “Create New Case” link 660 may direct the user 310 to a system for creating a new case in the database 110. For example, the “Create New Case” link 660 may present a “Create New Case” website page, such as a request for selected information relating to the new case. Referring to FIG. 2, an exemplary case data form 200 may include fields in a table for receiving information, such as case title, case number, date filed, jurisdiction, and various debtor information. The user 310 may provide the information in the fields, and the information may be stored in the database 110 and within each corresponding database table for subsequent use, for example to populate similar fields in other forms or to repopulate the fields of the case data form 200 when recalled for review. In the present embodiment, the user 310 may select a CREATE button, which may initiate the appropriate functions of the processing components 105 as described above to store the information in the database 110. The case data form 200 is merely one exemplary form that may comprise fields that rely upon and exchange information stored in the database 110, and other forms may likewise comprise fields that rely upon and exchange information stored in the database 110.

The MANAGE USERS option 670 may allow the user 310, such as an administrator, to determine which other users may be authorized to work on particular cases stored in the database 110. The user 310 may also have the ability to create a new authorized user for a particular account to manage different cases at the same time. For example, the user 310 may provide information relating to a new user, such as the new user's username and password. The user 310 may choose a role for a particular user, such as case administrator or case worker, which may have different rights and functions for accessing the database 110. The user 310 may also provide other information, such as the user's first and last names and contact information, such as an email address and a telephone number. The user 310 may thus generate user accounts for various users that may access the bankruptcy management system 350 and have different rights and functions associated with their accounts.

The user 310 may assign various users to particular cases to give them access to the database 110 for that case. For example, the user 310 may select a particular case to be managed, such as from a list of accessible cases. The user 310 may also assign users to one or more cases, which allows the user to gain access to the information relating to the case, such as to view or modify the information in the database 110 relating to the case. The user 310 may also exclude a user from a particular case to block access or certain types of access.

Other links on the “My Work” website page 355 may provide access to other functions. For example, the website page 355 may provide links to request support 680 and/or link to the public access page 440. The information and links described and shown by the “My Work” website page 355 merely constitute an exemplary embodiment of how the “My Work” website page 355 may be configured, and other information and links may added and/or deleted as desired to facilitate managing the bankruptcy case.

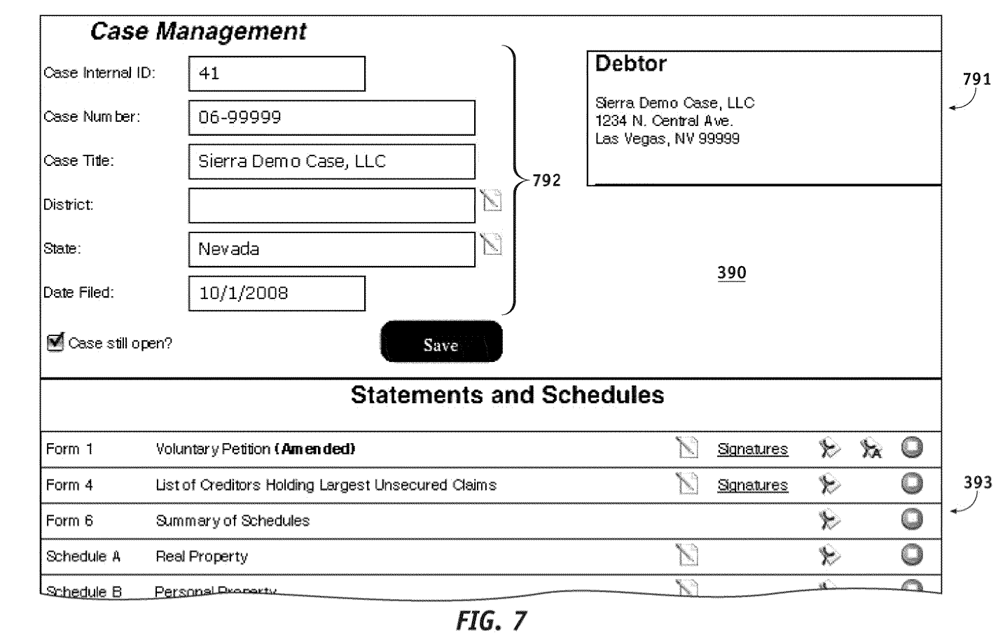

Referring again to FIGS. 3 and 6, the user 310 may select a case, for example by selecting one of the listed open cases 656. The user 310 may then be directed to a case management interface, such as a “Case Management” website page 390. Referring to FIG. 7, an exemplary Case Management website page 390 may comprise various information, fields, and links for reviewing and managing the bankruptcy case. For example, the website page 390 may comprise debtor information 791 that displays the debtor of the bankruptcy case. The website page 390 may also comprise other bankruptcy case identifying information 792, for example a case number, a case title, date filed, an internal ID reference, and the state and district the bankruptcy case may be adjudicated. The Case Management website page 390 may also comprise sections and/or links to other website pages to facilitate managing a bankruptcy case. For example, other sections comprising website pages may comprise “Statements and Schedules” 393, “Claims Processing” 394, “Proof of Claim” 395, “Ballots” 396, “Create Service Lists & Edit Party Information” 397, and/or CM/ECF (Court Manager/Electronic Court Filing) 398. Moreover, each of these other sections and/or website pages may comprise links to additional website pages for managing a bankruptcy case.

The Statements and Schedules functions may provide a listing of and/or links to Statements and Schedules that have been prepared or may be prepared for a particular case. In the present embodiment, a Statements and Schedules 393 module presents a listing of documents needed for a Chapter 11 bankruptcy case or other suitable type of case. The listing may comprise a listing of and links to the various Statements and Schedules documents needed to manage the bankruptcy case. For example, the Statements and Schedules 393 may comprise links, downloadable forms, and the like for typical bankruptcy documents. In an exemplary embodiment, the Statements and Schedules 393 may comprise Schedules A-H to disclose various real property, personal property, property claimed as exempt, creditors holding secured claims, creditors holding unsecured priority claims, creditors holding unsecured non-priority claims, executor contracts and unexpired leases, co-debtors, and the like. Moreover, the Statements and Schedules 393 may comprise various other forms, for example voluntary petitions, lists of creditors holding the largest unsecured claims, summary of schedules, declarations, statements of financial affairs, etc. These various schedules and documents are merely exemplary documents typically completed during a bankruptcy case, but other embodiments of the invention may comprise any additional documents, fewer documents, changed documents, etc.

Each document may be created and edited, such as by selecting the relevant document or form from a list. The bankruptcy case management system 350 may prepare pre-filled versions of documents, for example using templates and information from the database 110. The Statements and Schedules 393 module may also allow a user 310 to select a document for amendment, such as by selecting an AMEND button associated with the document. When a document is selected, the bankruptcy case management system 350 may present an image of the document for viewing or editing. When the document is complete, the user 310 may select to finalize documents for storage in the database 110.

The Case Management website page 390 may also facilitate designating various documents for public access, such as for viewing with having user rights for the particular case. In the present embodiment, the Case Management website page 390 includes a “Public Access Documents” button to activate a Public Access Documents module. The Public Access Documents module allows the user 310 to make any document on the case publicly accessible. For example, the Public Access Documents module may present a list of all of a case's Finalized Statements and Schedules or other documents. The user 310 may then select which files are to be made publicly available. The user 310 may also view a list of those documents that have been made public and control whether they remain public, as well as delete files. The Public Access Documents module may also facilitate uploading any other documents that are to be made public. Any such documents may then be accessed by other people and systems, such as via the PUBLIC ACCESS button.

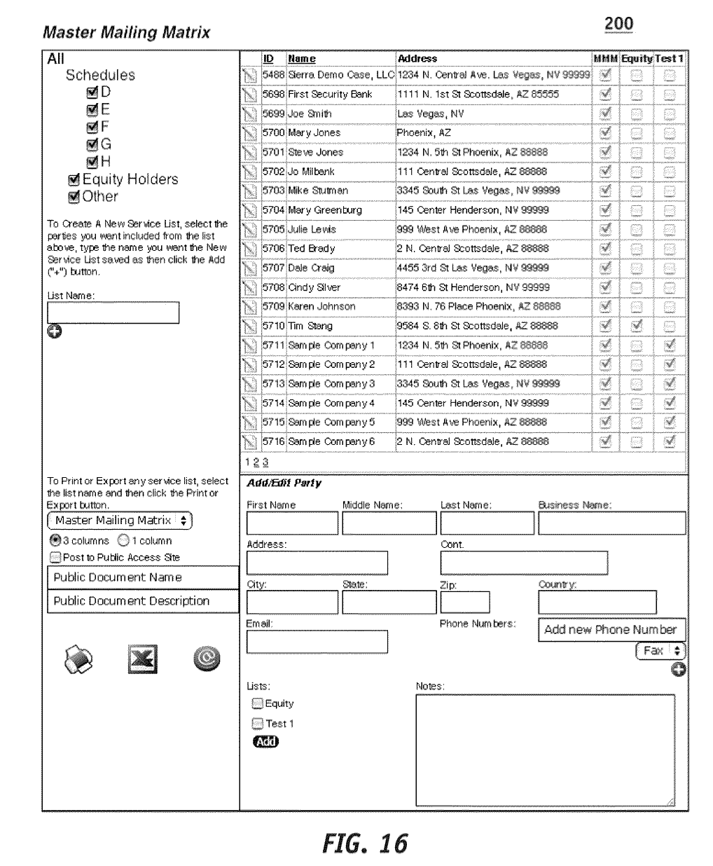

The bankruptcy case management system 350 may also facilitate preparation of service lists for serving the various parties to the case. For example, the user may select a Create Service Lists & Edit Party 397 option, which initiates a Create Service Lists & Edit Party module and may comprise a link to a Party and Service List website page, such as shown in FIG. 16. The Create Service Lists & Edit Party module may provide any appropriate functions for generating and using service lists for serving parties to the case. For example, the Party and Service List website page may present a list of all the creditors on file from the different statements and schedules or the returned proofs of claims, such as in the form of a master mailing matrix. The user 310 may edit the creditor information, such as by selecting an edit button and making the desired changes. The Party and Service List website page may also present an option for adding new parties and their relevant information, such as name, address, and comments.

The Party and Service List website page may also include filter and search functions, such as to filter creditors according which schedule the creditor is listed on, equity position, or other criteria. The search and filter functions may facilitate creating custom service lists for serving the various parties to the case. The lists may be exported to other programs, such as to Microsoft Word or Excel or Adobe Acrobat to facilitate mailing, and may also be exported to the Public Access area.

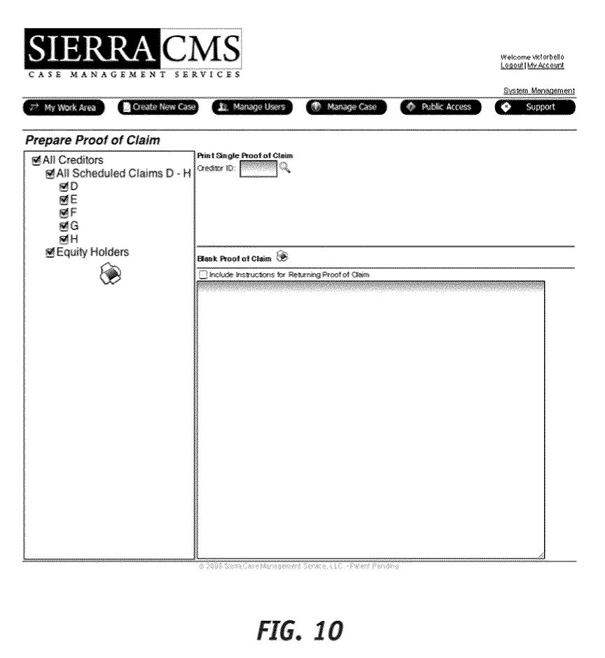

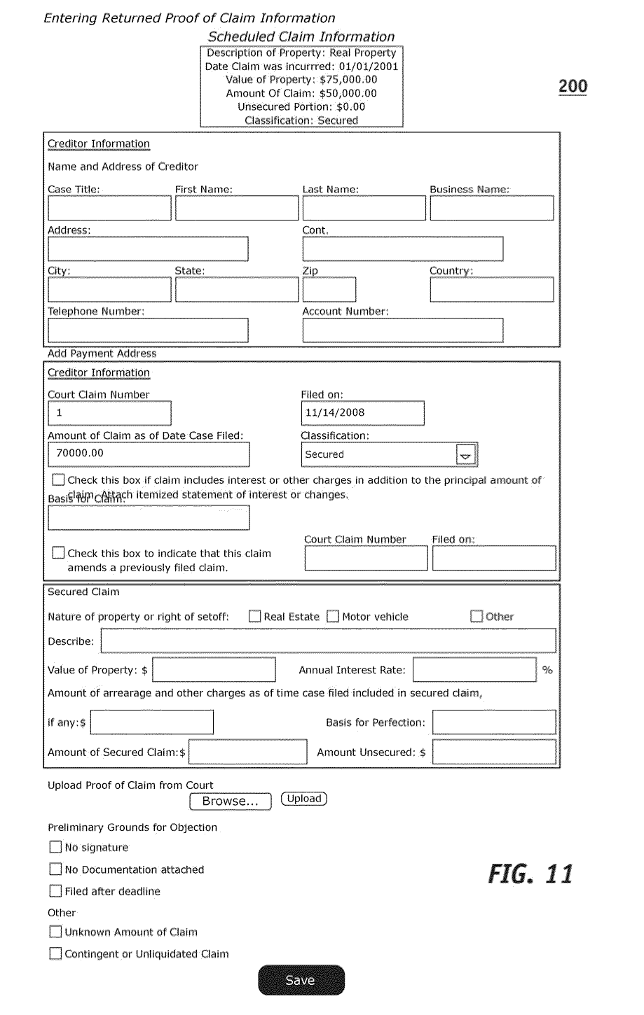

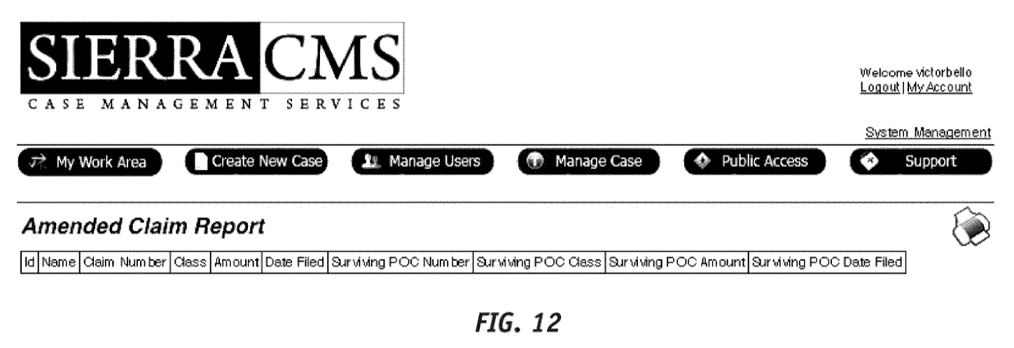

The Proof of Claim functions facilitate the creation and management of records relating to proofs of claims. The Proof of Claim functions may be implemented via various modules accessible via a Proof of Claim website section 395, such as to create proofs of claims, record proofs of claims as they are filed, and prepare reports relating to proofs of claims. In the present embodiment, the Proof of Claim website section 395 may comprise links to a “Create Proof of Claims” page 383 as shown in FIG. 10, an “Enter Returned Proof of Claim” page 384 as shown in FIG. 11, and/or an “Amended Claim Report” page 385 as shown in FIG. 12.

A proof of claim may be generated in any appropriate manner. In one embodiment, the bankruptcy case management system 350 includes a Proof of Claim module that presents the “Create Proof of Claim” page 383 as shown in FIG. 10. The Proof of Claim module may include a filter function for selecting creditors to include on a proof of claim report. When the relevant creditors have been selected, the Proof of Claim module may create a report, such as in a .pdf format or other suitable format. The Proof of Claim module may automatically insert the appropriate information from the database 110 to complete the proof of claim. The Proof of Claim module may also prepare a proof of claim for a single creditor, such as by entering a creditor's identification code. Special instructions may also be provided by the user, which may be automatically appended to or integrated into the proof of claim. The proof of claim may then be printed or stored in the database 110.

The bankruptcy case management system 350 may also process a returned proof of claim. For example, the user 310 may select an “Enter Returned Proof of Claim” option to activate an Enter Returned Proof of Claim module, which presents the “Enter Returned Proof of Claim” page 384 as shown in FIG. 11. The Enter Returned Proof of Claim module may provide any suitable functions for processing a proof of claim filed in a case. For example, an exemplary Enter Returned Proof of Claim module may facilitate searching for the relevant creditor, such as by an identification code or the creditor's name, or may permit creation of a new party for a proof of claim from an unscheduled creditor. When the relevant creditor is selected, information relating to the proof of claim may be provided, such as court claim number, filing date, amount of the claim, classification and other information as to securitization and priority, basis for the claim, and the like. A copy of the proof of claim, such as a pdf image, may be associated with the record. The Enter Returned Proof of Claim module may also provide options for noting preliminary grounds for objection. The information provided via the Enter Returned Proof of Claim module may be saved in the database 110.

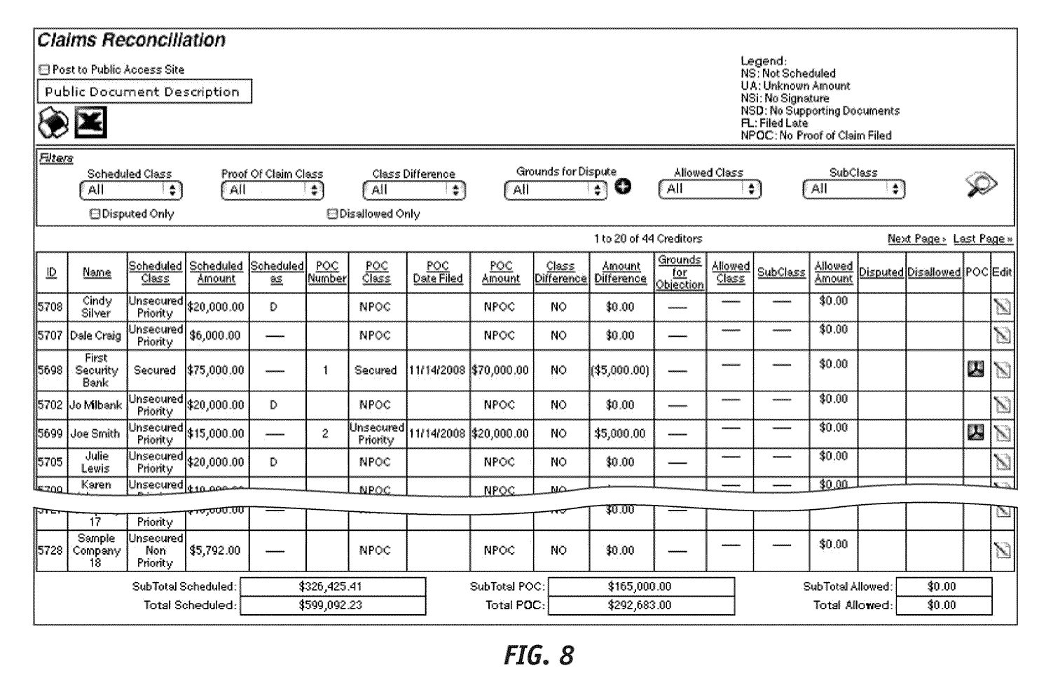

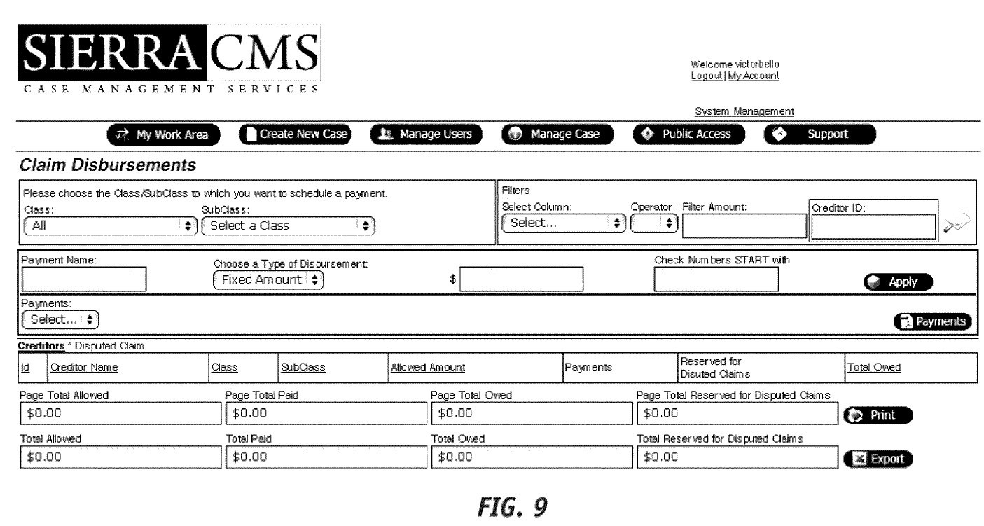

The Claims Processing functions facilitate processing claims, for example to disburse funds for claims and reconcile claims. The Claims Processing functions may be implemented via various modules accessible via a Claims Processing website section 394, such as for reconciling claims and disbursing funds. In the present embodiment, the Claims Processing website section 394 may comprise links to a “Claims Reconciliation” page 381 as shown in FIG. 8, and/or a “Claim Disbursement” page 382 as shown in FIG. 9.

The claims for a particular bankruptcy case may be managed in any appropriate manner. In one embodiment, the bankruptcy case management system 350 includes a Claim Reconciliation module that presents the “Claims Reconciliation” page 381 as shown in FIG. 8. The Claim Reconciliation module may facilitate managing claims, such as by presenting the claims of all creditors and their relevant information, for example the name, identification code, scheduled amount and class, proof of claim number, amount differences, class differences, amount, and other relevant information. The Claim Reconciliation module may also provide filter and search functions for finding and selecting particular creditors or groups of creditors, such as by scheduled class, proof of claim class, class difference, grounds for dispute, whether claims were disallowed, allowed class, or subclass. The Claim Reconciliation module may also permit the user 310 to change the allowed amount and class for a creditor, as well as assign subclasses to claims. Any filed proof of claim may also be associated with the creditor listing, which may be accessed by selecting a button or other suitable mechanism.

In addition, the Claim Reconciliation module may permit entry of allowed amounts to various creditors, as well as assign subclasses for claim disbursements. The Claim Reconciliation module may also allow the user 310 to review and make changes to the grounds for objection associated with the allowances, and may note whether a claim is disputed or disallowed. The information provided by the user may then be saved in the database 110. Allowed amounts may appear on the creditor list on the “Claims Reconciliation” page 381.

The bankruptcy case management system 350 may also include a Claim Disbursements module that presents the “Claims Disbursements” page 382 as shown in FIG. 9. The Claim Disbursements module facilitates review of all allowed amounts that have been assigned to the creditors on file. The Claim Disbursements module may include search and filter functions to select creditors or groups of creditors to receive payments, such as by class and subclass like secured, unsecured priority, unsecured nonpriority, administrative, or other suitable class or subclass, or by amounts allowed or owed.

The user 310 may then enter payment information for the selected creditors. The payments may be described in any suitable manner. For example, the user 310 may schedule a fixed amount or a percentage of the allowed amount, which will be automatically calculated. The description may include other relevant information, such as the check numbers for payments. The payments may then be applied to the claims of the creditor, and may be reviewed under the “payments” column. Scheduled payments may also be deleted if appropriate, and the user 310 may generate reports of all the payments on file using the Claim Disbursements module and the information in the database 110.

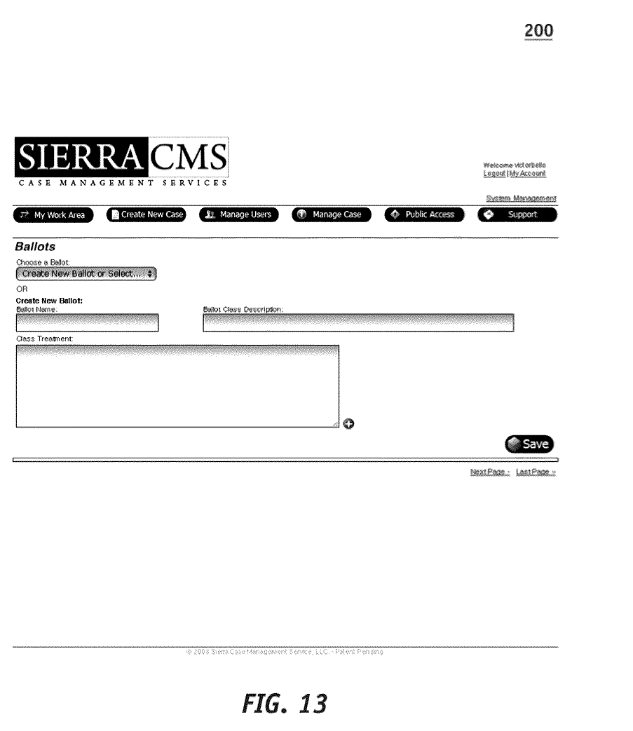

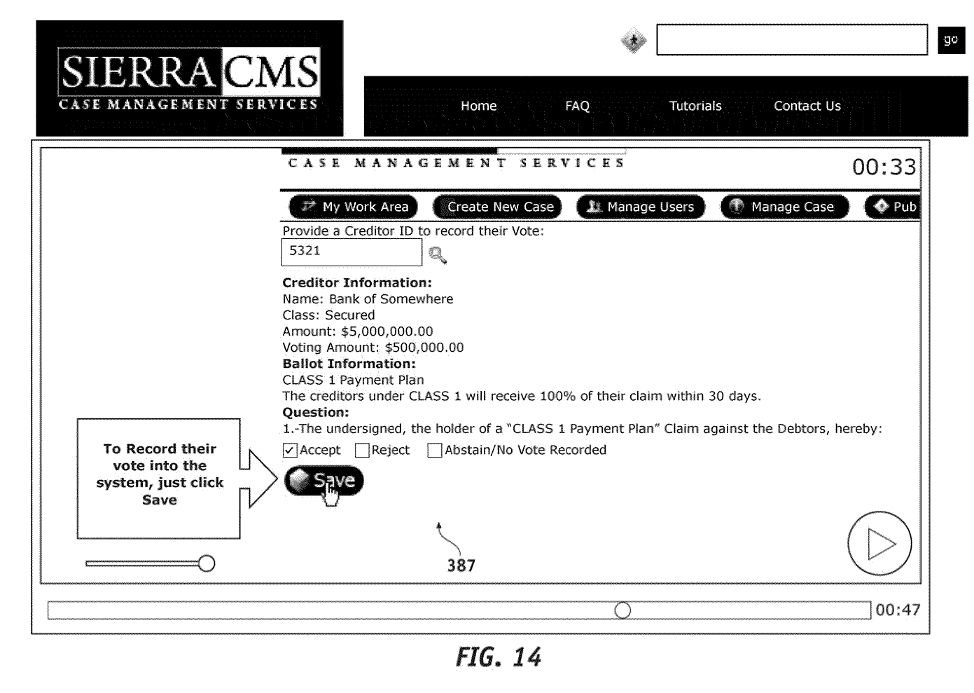

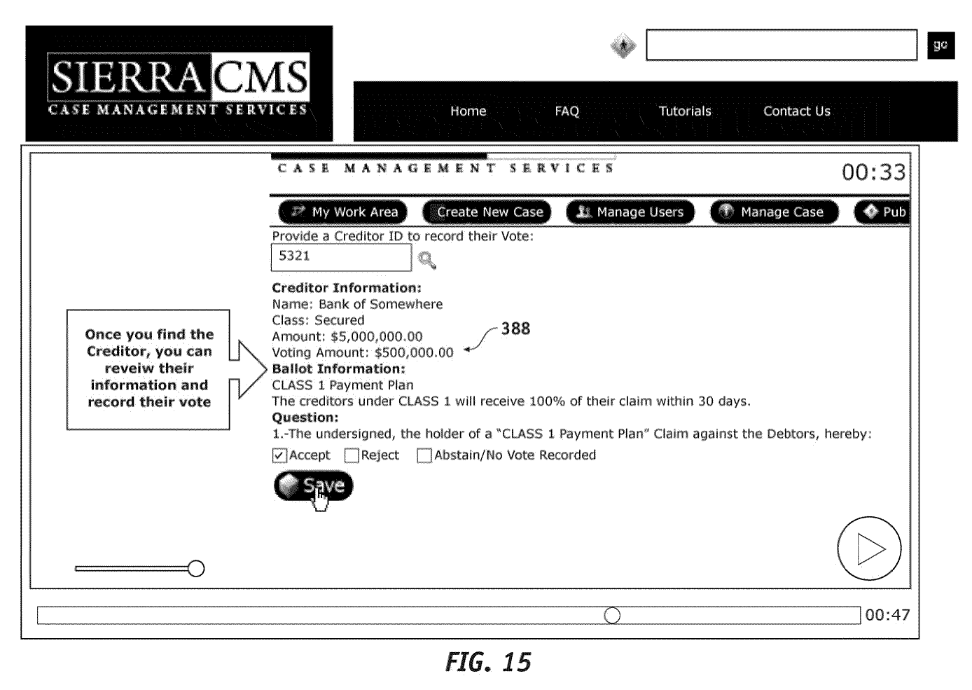

The Ballots functions facilitate working with ballots, such as creating ballots, recording ballot votes, and generating balloting results. The Ballots functions may be implemented via various modules accessible via a Ballots website section 396. In the present embodiment, the Ballots website section 396 may comprise links to a “Create/Print Ballots” page 386 as shown in FIG. 13, a “Record Ballot Votes” page 387 as shown in FIG. 14, and/or a “Balloting Results” page 388 as shown in FIG. 15.

The balloting for a particular bankruptcy case may be managed in any appropriate manner. In one embodiment, the bankruptcy case management system 350 includes a Create/Print Ballots module to create and mail ballots to creditors. For example, referring to FIG. 13, the Create/Print Ballots module may present the “Create/Print Ballots” page 386. The user 310 may choose a ballot, such as creating a new ballot or accessing existing ballots to add or remove voting creditors. The user 310 may provide or review ballot information, such as ballot name, class description, and treatment. The Create/Print Ballots module may present a list of all the creditors for a case, and the user can add or remove selected creditors to and from the ballot, as well as adjust information such as each creditor's allowed voting amount. The Create/Print Ballots module may also indicate how and whether each creditor voted on the ballot. Further, the user 310 may add one or more questions to the ballots and insert and edit the language for the ballots. The created ballot or modifications to the ballot may be stored in the database 110.

The bankruptcy case management system 350 may also record votes received from creditors, such as by recording votes received on returned ballots. For example, the user 310 may select the “Records Ballot Votes” option, which initiates a Record Ballot Votes module. The Record Ballot Votes module may present the “Record Ballot Votes” page 387 as shown in FIG. 14. The user 310 may initially enter an identifier or search for the creditor submitting the ballot. When the voting creditor is found, the vote of the creditor may be recorded, such as by checking a box for “accept”, “reject”, or “abstain/no vote recorded”. The voting information may then be saved in the database 110. The balloting results may be reviewed by selecting the “Balloting Results” option, which may initiate a Balloting Results module. The Balloting Results module may generate reports based on the balloting, such as counts of votes and numbers of returned ballots.

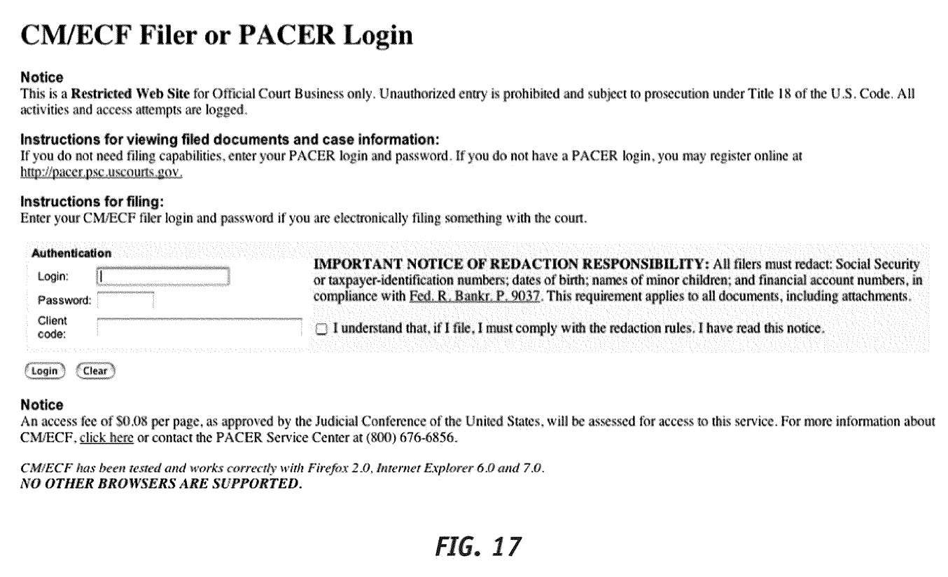

The bankruptcy case management system 350 may also include other functions, such as for filing or retrieving documents remotely in the relevant court. For example, referring to FIG. 17, the bankruptcy case management system 350 may include the CM/ECF section to link to a website page to facilitate filings in a court. In one embodiment, the bankruptcy case management system 350 may include systems for accessing other systems, such as court systems like PACER to facilitate data gathering and provide for electronic court filings (“ECF”).

A computer system 100 according to various aspects of the present invention may thus provide a web-based system for managing bankruptcy cases. The bankruptcy case management system 350 may prepare bankruptcy statements, schedules, proofs of claims, and other documents. The bankruptcy case management system 350 may prepare all of the required statements of financial affairs and the schedules of assets and liabilities and other forms for bankruptcy cases, such as Chapter 11 cases. The bankruptcy case management system 350 may also manage claims reconciliation and disbursements and streamline the claim objection and balloting processes, thus enhancing case administration processes and reducing costs.

The foregoing description of the present invention is merely an exemplary embodiment description and other configurations of computer system 100, processing components 105, website pages, and the like may be configured in other manners, configurations, and permutations to provide a user with a centralized system for managing bankruptcy cases. In the foregoing specification, the invention has been described with reference to specific exemplary embodiments. Various modifications and changes may be made without departing from the scope of the present invention as set forth in the claims. The specification and figures are illustrative, rather than restrictive, and modifications are intended to be included within the scope of the present invention. Accordingly, the scope of the invention should be determined by the claims and their legal equivalents rather than by merely the examples described.

For example, the steps recited in any method or process claims may be executed in any appropriate order and are not limited to the specific order presented in the claims. Additionally, the components and/or elements recited in any apparatus claims may be assembled or otherwise operationally configured in a variety of permutations and are accordingly not limited to the specific configuration recited in the specification and shown in the drawings.

Benefits, advantages, and solutions to problems have been described above with regard to particular embodiments. Any benefit, advantage, solution to problem or any element that may cause any particular benefit, advantage or solution to occur or to become more pronounced are not to be construed as critical, required or essential features or components of any or all the claims.

As used in this description, the terms “comprise”, “comprises”, “comprising”, “having”, “including”, “includes” or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present invention, in addition to those not specifically recited, may be varied or otherwise particularly adapted to specific environments, manufacturing specifications, design parameters or other operating requirements without departing from the general principles of the invention.

1. A computer system comprising medium storing instructions configured to manage a bankruptcy case comprises:
a web-site to provide an interface for a user to access at least one computer program for managing the bankruptcy case;
a database to electronically store bankruptcy case data; and
a web service configured to provide inter-connectivity between the web-site, the database, and the at least one computer program.

2. A computer system according to claim 1, wherein the user comprises one selected from the group comprising a debtor, a creditor, a court employee, and a bankruptcy case manager.

3. A computer system according to claim 2, wherein the bankruptcy case manager comprises at least one of a bankruptcy attorney and a paralegal.

4. A computer system according to claim 1, wherein the at least one computer program comprises a database access and editing program, a document access and editing program, and a bankruptcy case information program.

5. A computer system according to claim 1, wherein the computer program is configured to interface with at least one of PACER and an electronic court filing program.

6. A computer system according to claim 1, wherein the computer program is configured to at least one of generate, print, save, and provide for editing of a bankruptcy case management document.

7. A computer system according to claim 6, wherein the bankruptcy case management document comprises at least one selected from the group comprising a ballot, a ballot result, a proof of claim, a claim report, a claim disbursement, a bankruptcy statement, a schedule, a label, a claim objection, a bankruptcy case report, and a voluntary petition.

8. A computer system according to claim 7, wherein the bankruptcy case management document comprises at least one of an electronic document and a hard-copy document.

9. A computer system according to claim 7, wherein the bankruptcy case document can be accessed freely by the public or by a secured authorized user.

10. A computer system according to claim 7, wherein the bankruptcy case management document comprises at least one of manually entered data and document data populated from the electronically stored bankruptcy case data.

11. A computer system according to claim 7, wherein the schedule comprises at least one of a Schedule A to record real property information, a Schedule B to record personal property information, a Schedule C to record property claimed as exempt information, a Schedule D to record creditors holding secured claims information, a Schedule E to record creditors holding unsecured priority claims information, a Schedule F to record creditors holding unsecured non-priority claims information, a Schedule G to record executor contracts and unexpired leases information, and a Schedule H to record co-debtor information.

12. A computer system according to claim 1, wherein the medium storing instructions provide for at least one software environment.

13. A computer system according to claim 12, wherein the at least one software environment comprises at least one of a development environment, a quality assurance environment, and a production environment.

14. A computer system according to claim 1, wherein the computer program comprises a data access layer.

15. A computer system according to claim 14, wherein the data access layer comprises a dynamic link library.

16. A computer implemented method to manage a bankruptcy case comprises:
accessing a web-site comprising at least one computer program for managing the bankruptcy case; and
interfacing with at least one bankruptcy case management computer program, wherein the computer program comprises at least one of, a database to electronically store bankruptcy case data information, and a web service configured to provide inter-connectivity between the web-site and the at least one computer program.

17. A computer implemented method according to claim 16, wherein the computer program is further configured to at least one of generate, print, save, and provide for editing of a bankruptcy case management document.

18. A computer implemented method according to claim 17, wherein the bankruptcy case management document comprises at least one of a ballot, a ballot result, a proof of claim, a claim report, a claim disbursement, a bankruptcy statement, a schedule, a label, a claim objection, a bankruptcy case report, and a voluntary petition.

19. A computer implemented method according to claim 17, wherein the bankruptcy case management document comprises at least one of a Schedule A to record real property information, a Schedule B to record personal property information, a Schedule C to record property claimed as exempt information, a Schedule D to record creditors holding secured claims information, a Schedule E to record creditors holding unsecured priority claims information, a Schedule F to record creditors holding unsecured non-priority claims information, a Schedule G to record executor contracts and unexpired leases information, and a Schedule H to record co-debtor information.

20. A computer implemented method according to claim 16, wherein the computer program further comprises a data access layer.
